(19) United States
(12) Patent Application Publication
(10) Pub. No.: US 2003/0187133 A1
(43) Pub. Date: Oct. 2, 2003

(54) Polyisocyanate composition

(76) Inventor: Jean-Marie Bernard, Mornant (FR)

Correspondence Address: Jean-Louis Seugnet, Rhodia Inc, Intellectual Property Department, 259 Prospect Plains Road CN 7500, Cranbury, NJ, 08512-7500, US

(21) Appl. No.: 10/362,887

(22) PCT Filed: Jul. 31, 2001
(86) PCT No.: PCT/FR01/02504

(30) Foreign Application Priority Data
Aug. 4, 2000 (FR) 0/10364

(51) Int. Cl. C08K 3/00

(52) U.S. Cl. 524/589

(57) ABSTRACT

The invention concerns a polyisocyanate composition, wherein 0 to 100% of NCO functions are masked, and comprising the product of homo-oligomerization or hetero-oligomerization or homopolymerization or heteropolymerization of at least: (1) a polyisocyanate monomer of formula (I); (2) with, if required, one or several other compounds comprising at least an isocyanate function, optionally masked, and optionally another function reactive with the isocyanate function; and (3) optionally, one or several monofunctional masking agents reactive with the NCO function.

The present invention relates to polyisocyanate compositions and their use for the manufacture of coatings.

It relates, in addition, to the use of the above polyisocyanates in compositions for the preparation of polymers, in particular of polycondensates and crosslinked products derived from the reaction of said polyisocyanates and of nucleophilic coreagents. This preparation is that which is exploited in industrial applications, such as coatings of various types and in particular those on textiles, glass, paper, metals and building materials.

The present invention also relates to a process for producing these novel polyisocyanates.

A need exists for compositions having a high level of potential isocyanate functional groups, in particular in the form of powders which are capable of forming, by polymerization with compounds which react with said isocyanate functional groups, polymers having applications in the field of coatings, in particular polymers forming a dense network.

The present invention satisfies these needs and provides novel compounds having a high level of potential isocyanate functional groups, and leading to coatings or to the constitution of networks.

These compounds exist in the form of hydro- or organo-dispersible, or hydro- or organo-soluble products, some being in powdered form.

The subject of the invention is thus a polyisocyanate composition in which from 0 to 100% of the NCO functional groups are masked, and comprising the product of homo- or hetero-oligomerization or -polymerization of at least:

(1) a polyisocyanate monomer of the following formula I:

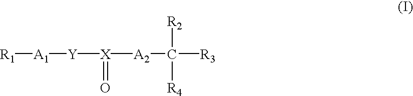

in which

A₁ and A₂, which are identical or different, represent a single bond or an aliphatic, cycloaliphatic or aromatic hydrocarbon chain optionally interrupted by one or more atoms, which are identical or different, chosen from O, S, Si, N and P, or a heterocyclic chain, said hydrocarbon or heterocyclic chain being optionally substituted by one or more substituents, which are identical or different, chosen from a halogen atom, a group —O, —S, OR₅, C(O)OR₅, OC(O)R₅, C(O)R₅, NR₅R₆, SO₂R₅, S(O₂)OR₅, C(O)NR₅R₆, P(O)R₅R₆, P(O)(OR₅)R₆, OP(O)R₅R₆, P(O)(OR₅)₂, OP(O)(OR₅R₆)₂ and OP(O)(OR₅)(OR₆),

in which R₅ and R₆, which are identical or different, are chosen from an alkyl, cycloalkyl, aryl, alkaryl and aralkyl group optionally interrupted by one or more heteroatoms chosen from O, S, N, Si and P, or a heterocycle,

R₁ and R₂, which are identical or different, represent H, an alkyl group or the group:

A₃-NCO

in which A₃ is as defined for A₁, the NCO function being optionally masked;

R₃ and R₄, which are identical or different, represent a group R₁ as defined above with the exception of a hydrogen atom, or R₃ and/or R₄ represent a group:

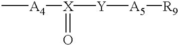

A₄ and A₅ being as defined above for A₁, and R₉ being as defined for R₁,

X is chosen from a carbon atom, a group SO and a group POR₅, R₅ being as defined above;

Y is chosen from a group O and NR₅, R₅ being as defined above

with the proviso that at least two groups among R₁, R₂, R₃ and R₄ carry an optionally masked NCO functional group;

(2) with, where appropriate, one or more other compounds comprising at least one optionally masked isocyanate functional group, and optionally another functional group which reacts with the isocyanate functional group, and

(3) optionally, one or more monofunctional masking agents which react with the NCO functional group.

In the monomers described above, the NCO functional groups may be partially or completely masked.

Advantageously, at least one, preferably at least two, more preferably at least three of the following conditions are fulfilled:

X represents a carbon atom;

Y represents an oxygen atom;

A₁ represents a single bond or a linear or branched C₁-C₄₀ alkylene chain, preferably a (CHR₇)ₙ chain with n being an integer from 1 to 40,

advantageously from 1 to 20 and preferably from 1 to 8 and R₇ being a C₁-C₂₀ alkyl group, preferably the methyl group;

A₂ represents a single bond;

R₁ represents a C₁-C₆ alkyl group or R₁ represents NCO-A₃, A₃ being as defined for A₁, namely a single bond or a linear or branched C₁-C₄₀ alkylene chain, preferably a (CHR₇)ₙ chain with n is an integer from 1 to 40, advantageously from 1 to 20 and preferably from 1 to 7 and R₇ is a C₁-C₂₀ alkyl group, preferably the methyl group;

R₂ represents a hydrogen atom;

R₃ and/or R₄ represent a group A₃-NCO, in which A₃ is a bond or a linear or branched C₁-C₄₀ alkylene chain, preferably a (CHR₇)ₙ group, with n is an integer from 1 to 40, R₇ as defined above, the NCO functional group being optionally masked; or R₃ represents a group A₃-NCO in which A₃ is a chain as defined above, with n is an integer from 1 to 40 and R₄ represents a group A₃-NCO in which A₃ is a single bond, the NCO functional groups being optionally masked.

The hydrocarbon chains defining A₁, A₂ and A₃ are advantageously linear or branched C₁-C₄₀ alkylene chains consisting of (CHR₇)ₙ links, n being an integer between 1 and 40, preferably between 1 and 20, advantageously between 1 and 6.

Other advantageous chains comprise [—O(CHR₇)ₘ]ₙ linkages, m being an integer being equal to 2, 3 or 4, and n being as defined above.

Also advantageous are the alkylene chains substituted with fluorine groups, in particular comprising groups (CR₈R₉)ₙ or [—O(C(R₈R₉)ₘ]ₙ in which R₈ and/or R₉ are as defined for R₇, at least one of R₈ and R_{g} however representing a fluorine atom. It is preferable that R₈ and R₉ both represent a fluorine atom.

Other preferred chains are chains comprising linkages:

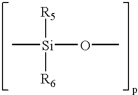

R₅ and R₆, which are identical or different, being as defined above and p representing an integer from 1 to 50.

In the other cases, the hydrocarbon chain advantageously comprises at most 20, preferably at most ten links as defined above.

When the hydrocarbon chain comprises side groups which react with the isocyanate functional group, they are generally protected with the aid of any customary protecting groups.

There may be mentioned by way of example of protecting groups:

for the NH₂ functional group, the following groups: carbamate, in particular methyl or ethyl carbamate, acyl, in particular acetyl, tosyl, perfluoro-fluoroacyl, in particular trifluoroacetyl or imide;

for the OH functional group, the following groups: ester, in particular acetyl or 2-ethylhexanoyl, carbonate, carbamate;

for the SH functional group, the thiocarbamate or thioether groups, and the like.

For all these functional groups and others, reference may be made to the book “Protective Groups in Organic Synthesis”, second edition, Theodora W. Greene and Peter G. M. Wuts; Wiley-Interscience.

These protecting groups may be heat-labile, heat-curable or curable by irradiation or radical initiation.

In general, the monomeric compounds (I) are preferred in which the groups:

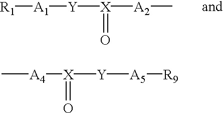

do not comprise an active hydrogen atom capable of reacting with a free isocyanate functional group of the monomeric compound, so as to avoid homopolymerization of the monomer of formula (I) itself.

In the case where the isocyanate functional group is protected with a protecting group, this restrictive condition does not apply.

Thus, the monomeric compounds of formula I are preferred in which R₁ is H, A₁ is a bond and Y is the oxygen atom, which carry at least one free NCO functional group.

According to the invention, the term “alkyl” denotes a linear or branched hydrocarbon radical preferably having from 1 to 40 atoms, in particular from 1 to 20 carbon atoms, such as methyl, ethyl, propyl, isopropyl, butyl, tert-butyl, isobutyl, pentyl, hexyl, heptyl, octyl, 2-ethylhexyl, nonyl, decyl, undecyl, dodecyl, tridecyl, tetradecyl, pentadecyl, hexadecyl, heptadecyl, octadecyl, nonadecyl, eicosyl, behenyl, and the like.

The C₁-C₆ groups are however preferred.

The term “cycloalkyl” denotes saturated hydrocarbon groups which may be mono- or polycyclic and comprise from 3 to 20 carbon atoms, preferably from 3 to 12. More particularly preferred are the monocyclic cycloalkyl groups such as cyclopropyl, cyclobutyl, cyclopentyl, cyclohexyl, cycloheptyl, cyclooctyl, cyclononyl, cyclodecyl, cycloundecyl and cyclododecyl.

The term “aryl” represents a mono- or bicyclic aromatic hydrocarbon group comprising 6 to 20 carbon atoms, preferably 6 to 10, such as phenyl, naphthyl or phenanthryl.

The term “alkaryl” is understood to mean an alkyl group as defined above, substituted with an aryl group, as defined above.

The term “aralkyl” is understood to mean an alkyl group as defined above, substituted with an aryl group, as defined above.

The term “halogen” is understood to mean a fluorine, chlorine, bromine or iodine atom, fluorine being preferred.

The term “alkylene” is understood to mean a linear or branched divalent group derived from an alkyl group as defined above by removing a hydrogen atom.

The term heterocyclic group denotes saturated or unsaturated, monocyclic, bicyclic or polycyclic, optionally aromatic, carbon rings having from 5 to 20 members and having from 1, 2 or 3 endocyclic heteroatoms chosen from O, N and S. They are generally derivatives of the heteroaryl groups described above. Preferably, the heterocycle, when it is unsaturated, comprises only one double bond. Preferred examples of unsaturated heterocycles are dihydrofuryl, dihydrothienyl, dihydropyrrolyl, pyrrolinyl, oxazolinyl, thiazolinyl, imidazolinyl, benzimidazolyl, benzotriazolyl, benzoxazolyl, pyrazolinyl, isoxazolinyl, isothiazolinyl, oxadiazolinyl, pyranyl and the monounsaturated derivatives of piperidine, dioxane, piperazine, trithiane, morpholine, dithiane, thiomorpholine, and tetrahydropyridazinyl, tetrahydropyrimidinyl, and tetrahydrotriazinyl.

Examples of aromatic heterocyclic groups are furyl, thienyl, pyrrolyl, oxazolyl, isoxazolyl, thiazolyl, isothiazolyl, imidazolyl, pyrazolyl, oxadiazolyl, triazolyl, thiadiazolyl, pyridyl, pyridazinyl, pyrazinyl and triazinyl groups.

When one of the above groups represents an aryl group optionally condensed with an unsaturated heterocycle, the unsaturated heterocycle has from 5 to 7 members and preferably only one unsaturation in common with the aryl group.

One subgroup of particularly preferred compounds (1) corresponds to the following formula Ia:

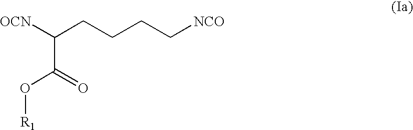

in which R₁ is an alkyl or (CH₂)ₙNCO group, n being an integer from 1 to 20, preferably from 1 to 6.

A first particularly preferred compound is the compound of formula Ia, in which R₁ represents the group (CH₂)₂—NCO, designated below by lysine triisocyanate (LTI).

A second particularly preferred compound is the compound of formula Ia, in which R₁ represents the methyl group, designated below by lysine diisocyanate (LDI).

A preferred family of compounds of general formula Ia is that in which at least one NCO group, preferably at least two NCO groups, and where appropriate, the three NCO groups, are masked.

The compounds of formula I comprising at least one, and preferably all the isocyanate functional groups masked with the aid of a masking agent customarily used in isocyanates chemistry are novel and constitute another subject of the invention.

The compounds of general formula I, as defined above, may be prepared by known organic chemistry processes.

Thus, when, in general formula (I), X represents a carbon atom and Y an oxygen atom, the compounds of formula (I) may be obtained by:

a) esterification of an amino acid of general formula (III)

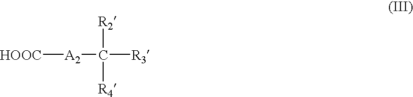

in which R₂′, R₃′ and R₄′ are as defined above for the groups R₂, R₃ and R₄, with the exception of the NCO groups which are replaced with amino groups, with a compound of general formula (IV):

R′₁A₁Z (IV)

in which Z represents an OH group or a halogen, in particular chlorine, atom and R′₁ is as defined for R₁, with the exception of the NCO groups which are replaced with NH₂ groups, and then

b) reaction of the amino groups with a reagent capable of converting the NH₂ functional group to an NCO functional group.

The reaction may also be carried out using, in place of the compounds of general formula (IV), where appropriate, corresponding alkenes.

The reaction of the compound of general formula (III) with the compound of general formula (IV) is generally carried out in the presence of an acid catalyst, such as hydrochloric acid or p-toluenesulfonic acid.

When the groups R′₁, R′₂, R′₃ or R′₄ comprise reactive side functional groups under the esterification conditions, it is preferable to protect them with the aid of a customary protecting group.

When the compound of general formula (III) is reacted with a compound of general formula (IV), in which Z represents a chlorine atom, it is preferable to start with the salt of the amino acid, in particular a metal (Cs, Na, K) salt or an ammonium salt (for example tetrabutylammonium or benzyltrimethylammonium), in a polar solvent.

When, in general formula (I), Y represents O and X represents POR₆, the compounds of general formula (I) may be obtained by processes equivalent to those described above, starting with the aminophosphoric salts in activated form, in particular in the form of acid anhydride halides.

When, in general formula (I), X represents SO and Y represents O, the corresponding compounds of general formula (I) are obtained from the corresponding aminosulfonic acid halides.

Reference may be made to the methods described in “Advanced Organic Chemistry, Third Edition; Jerry March, Wiley Interscience, pp. 444-445).

When, in general formula (I), Y represents NR₅, the compounds of general formula (I) may be obtained by means of a process as defined above in which the alcohol or the halide of formula (IV) is replaced with a corresponding amine.

The starting compounds of general formulae (III) and (IV) are known compounds which are commercially available or which may be prepared from commercially available amino acids with the aid of the customary processes in the field.

The process may be carried out starting in particular with the following amino acids: cysteine, lysine, ornithine, glutamic acid, aspartic acid, and the like.

For the general methods of synthesis, reference may be made to the book: “The Practice of Peptide Synthesis”, M. Bodanszky, A. Bodanszky, Springer Verlang, 1984 and “Methoden der Organischen Chemie”, vol. XV (1) and (2); Houben-Weyl; Georg Thieme Verlag, Stuttgart (1974).

When the chains A₁ to A₅ comprise —(OCHR₇)ₙ units, a polyethylene glycol monoalkyl ether, in particular polyethylene glycol monomethyl ether, is reacted with an appropriate amino acid in which the carboxylic acid functional group(s) are activated in ester, halide or acid anhydride form.

When the side chains are halogenated, for example fluorinated and in particular perfluorinated, it is advantageous to use an amino acid salt which is reacted with a monoiodoperfluoroalkane.

Alternatively, it is generally possible to react a perfluoroalkanol with a corresponding amino acid activated in halide or acid anhydride form.

When the chains A₁ to A₅ comprise —[(R₅)₂SiO]ₙ, the compounds of general formula (I) may be obtained by reacting a polysiloxane having a terminal SiH functional group, in the presence of a platinum compound with an alcohol in an anhydrous medium so as to obtain α,Ω-dihydroxylated compounds which may then be reacted with a compound of formula (III) in activated form.

Alternatively, it is also possible to react a polysiloxane having a pendent chain possessing an epoxy functional group with the amide of the starting amino acid protected on its amine functional group with a labile protecting group.

The conversion of the amines obtained at the end of the processes as described above to isocyanates may be carried out in particular by phosgenation, as described on page 370 of the book by March mentioned above.

According to a first variant, the compounds of general formula I may be polymerized with themselves by the isocyanate functional groups and the expression homooligomerization or homopolymerization will be used depending on the degree of polymerization.

Advantageously, the polyisocyanate composition of the invention comprises the product of dimerization, preferably trimerization of compounds of formula I with themselves.

According to a second variant of the invention, the polyisocyanate composition of the invention comprises the product of heteropolymerization of a compound (1) of general formula I as defined above, either with another compound of general formula I in which the substituents have different meanings, or with a compound (2) as defined above.

Preferred for compound (2) are the polyisocyanates, in particular the diisocyanates having a solely hydrocarbon backbone, that is to say comprising, apart from the NCO functional groups, only carbon and hydrogen atoms, generally designated by the name of monomers, and the products of oligomerization of one or more of these compounds with themselves or their products of precondensation with compounds having at least one functional group having an active hydrogen, in particular polyols or polyamines.

A subfamily of compounds (2) of this type includes the polyisocyanates derived from prepolymerization with an alcohol, at least a difunctional alcohol, or a polyamine, in particular a triamine, with a polyisocyanate, in general a diisocyanate, the quantity of isocyanate functional groups being greater than that of the functional groups having an active hydrogen (such as amines and/or alcohols), such that at the end of the prepolymerization, the number of residual isocyanate functional groups per molecule is on average greater than two, advantageously at least equal to 2.5; preferably at least equal to three.

It is also preferable that, in the monomeric compounds (2) of the invention, at least one of the isocyanate functional groups is aliphatic, that is to say carried by a carbon of hybridization (sp³) which, in addition, advantageously carries at least one, preferably two hydrogen atoms.

There may be mentioned in particular the products of condensation of isocyanates with hydroxylated compounds as described in EP 89 297.

In accordance with an advantageous modality of the invention, the polyisocyanates (2) reacted with a compound (1) of general formula I are chosen from the products of homo- or heterocondensation of alkylene diisocyanates, comprising in particular products of the “BIURET” type and of the “TRIMER” type, or even “PREPOLYMER” type having an isocyanate functional group comprising in particular urea, urethane, allophanate, ester or amide functional groups, and from mixtures containing them.

These may include, for example, the polyisocyanates marketed by the Applicant Company under the name TOLONATE®.

In general, the preferred polyisocyanates (2) are the compounds below or their products of homo- or heterocondensation of the following monomeric isocyanates:

1,6-hexamethylene diisocyanate,

1,12-dodecane diisocyanate,

cyclobutane 1,3-diisocyanate,

cyclohexane 1,3- and/or 1,4-diisocyanate,

1-isocyanato-3,3,5-trimethyl-5-diiso-cyanatomethylcyclohexane (isophorane diisocyanate),IPDI),

2,4- and/or 2,6-hexahydrotoluylene diisocyanate,

hexahydro-1,3- and/or -1,4-phenylene diisocyanate,

perhydro-2,4′- and/or 4,4′-diphenylmethane diisocyanate,

1,3- and/or 1,4-phenylene diisocyanate,

2,4- and/or 2,6-toluylene diisocyanate, diphenylmethane 2,4′- and/or 4,4′-diisocyanate,

isocyanato-(4)-methyloctylene diisocyanate (LTI or NTI),

triphenylmethane 4,4′,4″-triisocyanate,

1,3-bisisocyanatomethylcyclohexane,

bisisocyanatomethylnorbornane (NBDI),

2-methylpentamethylene diisocyanate. 1,6-Hexamethylene diisocyanate (HDI), the cyclotrimer of 1,6-hexamethylene diisocyanate, that is to say the monoisocyanurate compound obtained by cyclotrimerization of 3 mol of HDI on itself, the cyclodimer of HDI, that is to say the uretidione compound obtained by cyclodimerization of 2 mol of HDI on itself, and the biuret and allophanate derivatives of these compounds are particularly preferred.

The masking group is provided by the reaction of a monofunctional masking agent with the isocyanate functional group.

The masking agent, which may be a mixture of masking agents, has most often at least one active hydrogen so that the masking reaction can be written:

Is-N═C═O+AM-H→Is-NH—CO(AM)

where AM-H represents the masking agent;

where AM- represents the masking group;

where Is is the residue carrying the isocyanate functional group considered.

Is may be the residue of a compound (1) or (2) after removal of the isocyanate groups.

Said masking agent has at least one functional group carrying an active, or more exactly reactive, hydrogen, a function for which it is possible to define a pKa, which corresponds either to the ionization of an acid, including the hydrogen of the functional groups, phenols and alcohols, or to the acid associated with a base, in general a nitrogenous base. The pKa of the functional group having hydrogens is at least equal to 4, advantageously to 5, preferably to 6 and is at most equal to 14, advantageously to 13, preferably to 12, and more preferably to 10, it being necessary to make an exception for the lactams whose pKa is greater than these values and which constitute masking agents which are nevertheless acceptable although not preferred for the invention.

Advantageously, the masking agent comprises only one active hydrogen.

By way of nonlimiting examples of the masking agents according to the invention, there may be mentioned derivatives of hydroxylamine such as hydroxysuccinimide and oximes such as methyl ethyl ketoxime, derivatives of phenols or the like, derivatives of amides such as imides and lactams, and malonates or keto esters and hydroxamates.

The nitrogen-containing heterocyclic groups comprising 2 to 9 carbon atoms and, in addition to the nitrogen atom, from 1 to 3 other heteroatoms chosen from nitrogen, oxygen and sulfur, are however more particularly preferred. Particularly preferred are the heterocycles comprising from 2 to 4 carbon atoms and from 1 to 3 nitrogen atoms, such as the pyrrolyl, 2H-pyrrolyl, imidazolyl, pyrimidinyl, pyridazinyl, pyrazinyl, pyrimidinyl, pyridazinyl, indolizinyl, isoindolyl, indolyl, indolyl, indozolyl, purinyl, quinolizinyl, isoquinolyl, pyrazolidinyl, imidazolidinyl and triazolyl groups, these groups being optionally substituted by one to three substitutents chosen from NH₂,NH(C₁-C₆)alkyl, N-di(C₁-C₆)alkyl, OH, SH, CF₃, C₁-C₆ alkyl, C₃-C₆ cycloalkyl, C₅-C₁₂ aryl, in particular phenyl, C₆-C₁₈ aralkyl having from 5 to 12 carbon atoms in the aryl group, in particular benzyl or C₆-C₁₈ alkaryl having from 5 to 12 carbon atoms in the aryl group.

The 1,2,3-triazolyl or 1,2,4-triazolyl groups are particularly preferred.

For the determination of the pKa values, reference may be made to “The determination of ionization constants, a laboratory manual, A. Albert of E. P. Serjeant; Chapman and Hall Ltd., London”.

For the list of blocking agents, reference may be made to Z. Wicks (Prog. Org. Chem., 1975, 3, 73 and Prog. Org. Chem., 1989, 9, 7) and Petersen (Justus Liebigs, Annalen der Chemie 562, 205, (1949).

The masking agent may be reacted with the compound (1) of general formula I and/or the isocyanate compound (2) before the actual oligomerization/ polymerization reaction.

The masking agent may also be reacted with the not completely masked polyisocyanate composition obtained by reacting compounds (1) and (2) which are not completely masked.

The polyisocyanate compositions of the invention comprising from 0.1 to 100%, advantageously from 1 to 100% by mass of masking groups, expressed relative to the mass of polyisocyanate composition, are generally preferred.

The oligomerization or polymerization reaction is advantageously performed in the presence of a catalyst which is customarily used in isocyanate chemistry, depending on the composition of the reaction product which it is desired to obtain.

The nature of the products of condensation depends on the catalyst used.

When the oligomerization reaction is a trimerization reaction, there may be mentioned in particular, as catalysts, weak acid salts or hydroxides of tetraalkylammoniums, weak acid salts or hydroxides of hydroxyalkylammoniums, metal salts of carboxylic acids, metal, in particular alkali or alkaline-earth metal, alkoxides or phenoxides, tertiary alkylphosphines, in particular those described in U.S. Pat. No. 3,211,703, silylated amines and hexamethyldisilozane (HMDZ).

The preferred catalysts are the quaternary ammonium compounds, in particular the hydroxides, hydrogen carbonates or carboxylates and the silylated derivatives, in particular HMDZ, and make it possible to predominantly obtain trimers with isocyanurate ring(s).

When quaternary ammonium or phosphonium fluorides as described in EP 962 454 are used, iminooxadiazinediones are predominantly obtained.

The reaction temperature depends on the catalyst. For quaternary ammoniums, the procedure is generally carried out at a temperature of the order of 400 to 100° C.

For the sylilated catalysts, higher temperatures may be tolerated and it is common to work at temperatures of the order of 100 to 140° C.

When the oligomerization reaction is a dimerization reaction, there may be mentioned, as catalysts, dialkylaminopyridines (U.S. Pat. No. 5,461,020) or hexamethylphosphorus triamides (HMPT) also called tris(N,N-alkyl)phosphines (U.S. Pat. No. 4,614,785).

It is also possible to carry out the procedure in the absence of catalyst and by heating the reaction medium to a temperature greater than 120° C. and less than 180° C.

When the-reaction is catalyzed, the reaction temperatures vary between 140 and 80° C.

Dimers with uretidinedione unit(s) are predominantly obtained.

The reaction temperatures depend on the levels of conversion desired by the operation. They are determined by measuring the quantity of isocyanate functional groups in the reaction medium.

Depending on the desired application, a level of conversion will be chosen according to the expected final viscosity.

When the polyisocyanate composition of the invention is obtained by oligo- or polymerization of compounds (1) of general formula I, the reaction product may be used as it is, without the need to remove the unreacted monomers (1).

When the reaction product is obtained from compounds (2) consisting of monomeric isocyanates as defined above, it is generally preferred to remove them by distillation.

Advantageous polyisocyanate compositions according to the invention are the compounds in powdered form.

A first group of compounds in powdered form comprises isocyanates of general formula I partially or completely masked with masking groups. Nitrogen-containing heterocyclic masking agents which generally give powders with ease are preferred.

A second group of compounds in powdered form comprises polyisocyanates comprising the product of homooligomerization of compounds (1) or of heterooligomerization of compounds (1) with compounds (2), in which 15 to 100%, advantageously 30 to 100% by mass of NCO functional groups are masked with the 1,2,4-triazolyl group.

When the starting isocyanates (1) or (2) possess preferably cycloaliphatic cyclic structures, the propensity to form a powder is increased.

The subject of the invention is also a composition as defined above, in which the isocyanate functional groups are masked, also comprising at least one compound having functional groups with a reactive hydrogen polycondensable with isocyanate functional groups, in general one or more polyols.

This polyol is a polymer which advantageously contains a hydroxyl value of between 0.001 and 20, advantageously between 1 and 3% (by mass).

The composition according to the present invention may also comprise a catalyst for releasing the masking group,.which is advantageously latent and which will only be activated during the reaction of polycondensation of the masked (poly)isocyanate composition with compounds having functional groups with a reactive hydrogen in particular under the effect of the polycondensation temperature.

The subject of the invention is, in addition, a process for using a composition described above, comprising the following steps:

application of a composition according to the invention in the form of a thick layer between 20 μm and 200 μm, advantageously between 25 and 100 μm;

heating to a heating temperature at least equal to 60° C., and preferably at least equal to 100° C.

The subject of the invention is finally a coating obtained by the above process.

The invention is illustrated by the following examples:

### EXAMPLE 1

Synthesis of N-α,N-ε-bis(1,2,4-triazolyl-carbonyl)lysine methyl ester

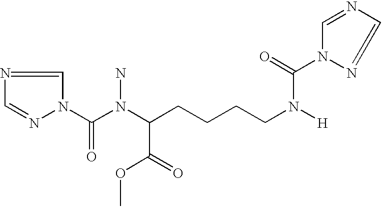

21.2 g of N-α,N-ε-diisocyanatolysine methyl ester, 60 ml of butyl acetate and 30.36 g of 1,2,4-triazole are successively introduced into a three-necked reactor provided with stirring.

The medium is stirred and the temperature begins to rise to 27° C. after a quarter of the reaction. The triazole solubilizes only slowly. The reaction medium is then heated to 80° C. After 50 minutes of reaction, the triazole is completely solubilized. The infrared spectrum produced on a sample of reaction mass gives an NCO titer close to 0. The heating of the reaction medium is then stopped and after one hour of reaction, the product is precipitated by adding 300 ml of diisopropyl ether to the medium. The solvent is removed and the product is ground in a mortar and then washed with isopropyl ether.

The product is then dried in an oven at 40° C. overnight. The quantity recovered is 42 g, that is a recovered yield of 81.5%. The powder is white.

The melting point of the product obtained is 85° C. (measurement carried out on a Kofler stage). The product is stable at 40° C. overnight without agglomerating. The potential NCO level is 24%.

### EXAMPLE 2

Synthesis of N-α,N-ε-bis(1,2,4-triazolyl-carbonyl)lysine (1,2,4-triazolylcarbonylamino)ethyl ester

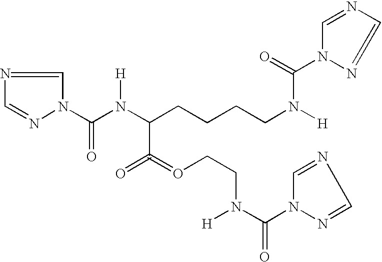

The same type of synthesis is carried out starting with N-α,N-ε-diisocyanatolysine isocyanatoethyl ester.

68 g of product are recovered, that is a yield of 94.6%. The powder is white.

The product has a melting point of 100° C. with an onset of softening from 75° C. (measurement carried out on a Kofler stage). The potential NCO level is 26.6%. The product is stable at 40° C. overnight.

The infrared spectra of the products obtained are in conformity with the expected products (negative NCO band at 2 250 cm⁻¹, pseudourea band and ester band at 1 725 and 1 760 cm⁻¹ respectively)

### EXAMPLE 3

Preparation of the Trimer LTI (lysine triisocyanate)

5 g of LTI are introduced into a 20 ml reactor, with stirring, and 100 mg of hexamethyldisilazane (HMDZ) are added. The reaction medium is heated at 120° C. for one hour. The reaction temperature is reduced to 80° C. and the reaction is stopped by adding butanol (100 mg).

5.1 g of the expected product are obtained.

Analysis of the reaction mixture shows the presence of isocyanurate and uretidinedione rings and of carbamate and isocyanate functional groups.

It is not necessary to distill the monomer because it has three reactive NCO functional groups which will participate in the formation of the network.

### EXAMPLES 4 to 8

Example 3 above is repeated, modifying the procedure.

The reaction conditions are described in table I below.

TABLE I

| | | Tempera- | Reaction | | Rate of conversion |
|---|---|---|---|---|---|
| | HMDZ | ture | time | BuOH | of the NCO func- |
| Ex. | (mg) | (° C.) | (hours) | (mg) | tional groups (%) |
| 3 | 100 | 120 | 1.0 | 100 | 25.8 |
| 4 | 100 | 120 | 2.5 | 100 | 29.4 |
| 5 | 100 | 120 | 4.0 | 100 | 32.1 |
| 6 | 200 | 120 | 2.5 | 200 | 25.4 |
| 7 | 50 | 120 | 2.5 | 50 | 28.1 |
| 8 | 50 | 120 | 4.0 | 50 | 31.6 |

The expected composition is obtained in all cases.

### EXAMPLES 9 to 12

Preparation of the Trimer LDI

The preparations are carried out in bulk.

The various reactions were monitored by assaying the NCO functional groups and the apparent rate of conversion was determined by the formula:

$$τ = \frac{( {N}_{NCO}^{initial} - {N}_{NCO}^{final} ) * 2}{{N}_{NCO}^{initial}}$$

It is the rate of conversion obtained considering that the trimer is exclusively synthesized. The products synthesized were analyzed by gel permeation chromatography on a Waters chromatogram provided with three columns of 500 Å, 100 Å and 50 Å (or simply 100 Å and 50 Å) and coupled to a refractometric detector. THF was used as eluent with a flow rate of 0.1 ml/min.

The infrared absorption spectra which made it possible to confirm the results were produced on a Perkin Elmer 882 apparatus, the products analyzed being placed between two NaCl faces.

### EXAMPLE 9

The reaction mixture is the following:

LDI: 150 g

then HMDZ: 1.8 g that is 1.2% by mass relative to the LDI.

The reaction profile is the following:

heating at 120° C. for 2 h 30 min;

addition of 1.8 g of HMDZ while the temperature is maintained at 120° C. for a further 2 h 30 min;

finally, increase of the temperature to 140° C. and continuation of the reaction for 1 h 30 min.

### EXAMPLES 10 to 12

Example 9 is repeated, varying the catalyst level and/or the reaction temperature.

Table II below summarizes the conditions for the procedures of examples 9 to 12.

TABLE II

| | Mass of | Mass of | Reaction | | |
|---|---|---|---|---|---|
| | LDI | HMDZ | temperature | Reaction | Conversion |
| Ex. | (g)* | (g)* | (° C.) | time | rate (%) |
| 9 | 100 | 1.2 | 120 | 2 h 30 min | 24 |
| | | +1.2 | 120 | 2 h 30 min | 24 |
| | | 140 | 1 h 30 min | 25 | |
| 10 | 100 | 2.4 | 120 | 2 h 30 min | 26 |
| 11 | 100 | 4.8 | 120 | 5 h 30 min | 30 |
| 12 | 100 | 4.8 | 140 | 12 h 00 min | 77 |
| | | | | | formation |
| | | | | | of heavy |
| | | | | | oligomers |

*adjusted to 100 g of reagent

Monitoring the synthesis reaction of example 11 by GPC shows that after two hours 30 minutes of reaction, the reaction medium practically no longer changes.

The GPC chromatograms of the various products show that in all cases, a mixture of the trimer and of higher oligomers is obtained.

The results of example 12, the very high degree of progress and the appearance of the GPC chromatogram show that at 140° C., oligomers of high mass are obtained. Infrared analysis made it possible to confirm the presence of the trimer by the characteristic bands of isocyanurates at v_{C═O}=1 688 cm⁻¹ and V_{C—N}=1 464 cm⁻¹.

One of the components of the LDI trimerization composition has the following structure:

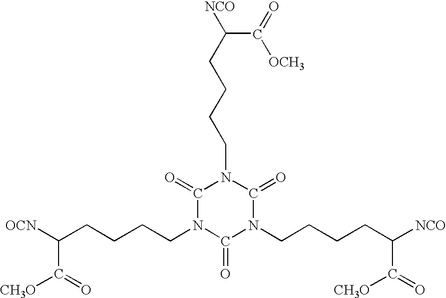

1. A polyisocyanate composition in which from 0 to 100% of the NCO functional groups are masked, and comprising the product of homo- or hetero-oligomerization or -polymerization of at least:
(1) a polyisocyanate monomer of the following formula I: 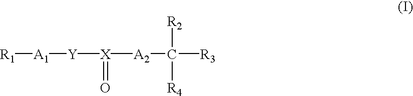
in which A₁ and A₂, which are identical or different, represent a single bond or an aliphatic, cycloaliphatic or aromatic hydrocarbon chain optionally interrupted by one or more atoms, which are identical or different, chosen from O, S, Si, N and P, or a heterocyclic chain, said hydrocarbon or heterocyclic chain being optionally substituted by one or more substituents, which are identical or different, chosen from a halogen atom, a group —O, —S, OR₅, C(O)OR₅, OC(O)R₅, C(O)R₅, NR₅R₆, SO₂R₅, S(O₂)OR₅, C(O)NR₅R₆, P(O)R₅R₆, P(O)(OR₅)R₆, OP(O)R₅R₆, P(O) (OR₅)₂, OP(O)(OR₅R₆)₂ and OP(O)(OR₅)(OR₆),
in which R₅ and R₆, which are identical or different, are chosen from an alkyl, cycloalkyl, aryl, alkaryl and aralkyl group optionally interrupted by one or more heteroatoms chosen from O, S, N, Si and P, or a heterocycle,
R₁ and R₂, which are identical or different, represent H, an alkyl group or the group:
A₃-NCO
in which A₃ is as defined for A₁, the NCO functional group being optionally masked;
R₃ and R₄, which are identical or different, represent a group R₁ as defined above with the exception of a hydrogen atom, or R₃ and/or R₄ represent a group: 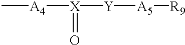
A₄ and A₅ being as defined above for A₁, and R₉ being as defined for R₁,
X is chosen from a carbon atom, a sulfur atom, a group SO and a group POR₅, R₅ being as defined above;
Y is chosen from a group O and NR₅, R₅ being as defined above
with the proviso that at least two groups among R₁, R₂, R₃ and R₄ carry an optionally masked NCO functional group;
(2) with, where appropriate, one or more other compounds comprising at least one optionally masked isocyanate functional group, and optionally another functional group which reacts with the isocyanate functional group, and
(3) optionally, one or more monofunctional masking agents which react with the NCO functional group.

2. The polyisocyanate composition as claimed in claim 1, in which X represents a carbon atom.

3. The polyisocyanate composition as claimed in claim 1 or claim 2, in which Y represents an oxygen atom.

4. The polyisocyanate composition as claimed in any one of the preceding claims, in which R, represents a linear or branched C₁-C₆ alkyl group.

5. The polyisocyanate composition as claimed in any one of the preceding claims, in which R₂ represents a hydrogen atom.

6. The polyisocyanate composition as claimed in any one of the preceding claims, in which R₃ and/or R₄ represent a group A₃-NCO, in which A₃ is a bond or a group (CHR₇)ₙ, with R₇ being a C₁-C₂₀ alkyl group and n being an integer from 1 to 40, the NCO functional group being optionally masked.

7. The polyisocyanate composition as claimed in claim 1, in which R₃ represents a group A₁-NCO where A₁ is a group (CHR₇)ₙ, R₇ being a C₁-C₁₀ alkyl group and n being an integer from 1 to 40 and R₄ represents a group A₂-NCO in which A₂ is a single bond, the NCO functional groups being optionally masked.

8. The polyisocyanate composition as claimed in claim 1, in which A₁ represents a single bond or a (CHR₇)ₙ chain, with R₇ being a C₁-C₂₀ alkyl group and n being an integer from 1 to 40.

9. The polyisocyanate composition as claimed in claim 1, in which R₃ represents a group A₁-NCO where A₁ is a group (CHR₇)ₙ, with R₇ being a C₁-C₂₀ alkyl group and n being an integer from 1 to 40 and R₄ represents a group A₂-NCO in which A₂ is a single bond.

10. The polyisocyanate composition as claimed in any one of the preceding claims, characterized in that the compound (1) corresponds to the general formula Ia: 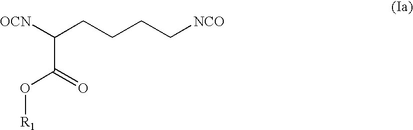
in which
R₁ represents a C₁-C₆ alkyl group or a group of formula (CH₂)ₙ—NCO, n being an integer between 1 and 6,
the NCO functional groups being optionally masked partially or completely.

11. The polyisocyanate composition as claimed in claim 1 or claim 10, comprising the product of homo-oligomerization or -polymerization of a compound of (1) of general formula I as defined as claimed in claim 1 or of general formula as defined in claim 10.

12. The polyisocyanate composition as claimed in claim 1 or claim 10, comprising the product of hetero-oligomerization or -polymerization of a compound (1) of general formula I as defined as claimed in claim 1, with another polyisocyanate compound (2) or of general formula Ia as defined in claim 10.

13. The polyisocyanate composition as claimed in claim 12, in which said compound (2) is a diisocyanate or a product of oligomerization or of polymerization of the diisocyanate with itself or one or more other diisocyanates.

14. The polyisocyanate composition as claimed in claim 13, in which said compound (2) is the product of cyclotrimerization of said diisocyanate.

15. The polyisocyanate composition as claimed in claim 13 or 14, in which said diisocyanate is hexamethylene diisocyanate.

16. The polyisocyanate composition as claimed in any one [lacuna] preceding claims, comprising from 0.1 to 100%, advantageously from [lacuna] to 100% by mass of masking groups, expressed relative to the mass of the polyisocyanate composition.

17. The polyisocyanate composition as claimed in any one [lacuna] claims 1 to 16, in which the masking agent is chosen from derivatives of hydroxylamine, derivatives of phenols, derivatives of amides, lactams, malonates, keto esters and hydroxamates.

18. The polyisocyanate composition as claimed in any one [lacuna] claims 1 to 16, in which the masking agent is a nitrogen-containing heterocycle.

19. The polyisocyanate composition as claimed in claim 18, in which the nitrogen-containing heterocycle is chosen from pyrrolyl, 2H-pyrrolyl, imidazolyl, pyrimidinyl, pyridazinyl, pyrazinyl, pyrimidinyl, pyridazinyl, indolizinyl, isoindolyl, indolyl, indolyl, indozolyl, purinyl, quinolizinyl, isoquinolyl, pyrazolidinyl, imidazolidinyl and triazolyl groups, these groups being optionally substituted by one to three substitutents chosen from NH₂,NH(C₁-C₆)alkyl, N-di(C₁-C₆)alkyl, OH, SH, CF₃, C₁-C₆ alkyl, C₃-C₆ cycloalkyl, C₅-C₁₂ aryl, in particular phenyl, C₆-C₁₈ aralkyl having from 5 to 12 carbon atoms in the aryl group, in particular benzyl or C₆-C₁₈ alkaryl having from 5 to 12 carbon atoms in the aryl group.

20. The polyisocyanate composition as claimed in claim 18, in which the masking agent is chosen from 1,2,3-triazolyl and 1,2,4-triazolyl.

21. The polyisocyanate composition in powdered form as claimed in claim 1, comprising the product of homooligomerization of compounds (1) or of heterooligomerization of compounds (1) with compounds (2), in which from 15 to 100%, advantageously from 30 to 100% by mass of NCO functional groups are masked by the 1,2,4-triazolyl group.

22. The polyisocyanate composition as claimed in any one of the preceding claims, in which the isocyanate functional groups are masked and also comprising at least one compound having functional groups with a reactive hydrogen polycondensable with the isocyanate functional groups, in general one or more polyols.

23. A compound of general formula I: 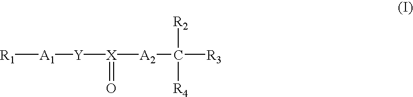
in which A₁ and A₂, which are identical or different, represent a single bond or an aliphatic, cycloaliphatic or aromatic hydrocarbon chain optionally interrupted by one or more atoms, which are identical or different, chosen from O, S, Si, N and P, or a heterocyclic chain, said hydrocarbon or heterocyclic chain being optionally substituted by one or more substituents, which are identical or different, chosen from a halogen atom, a group —O, —S, OR₅, C(O)OR₅, OC(O)R₅, C(O)R₅, NR₅R₆, SO₂R₅, S(O₂)OR₅, C(O)NR₅R₆, P(O)R₅R₆, P(O)(OR₅)R₆, OP(O)R₅R₆, P(O)(OR₅)₂, OP(O)(OR₅R₆)₂ and OP(O) (OR₅) (OR₆),
in which R₅ and R₆, which are identical or different, are chosen from an alkyl, cycloalkyl, aryl, alkaryl and aralkyl group optionally interrupted by one or more heteroatoms chosen from O, Si N. Si and P, or a heterocycle,
R₁ and R₂, which are identical or different, represent H, an alkyl group or the group:
A₃-NCO
in which A₃ is as defined for A₁;
R₃ and R₄, which are identical or different, represent a group R₁ as defined above with the exception of a hydrogen atom, or R₃ and/or R₄ represent a group: 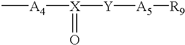
A₄ and A₅ being as defined above for A₁, and R₉ being as defined for R₁,
X is chosen from a carbon atom, a sulfur atom, a group SO and a group POR₅, R₅ being as defined above;
Y is chosen from a group O and NR₅, R₅ being as defined above
with the proviso that at least two groups among R₁, R₂, R₃ and R₄ carry an optionally masked NCO functional group;
in which at least one, advantageously at least two, and preferably all the NCO functional groups are masked with the aid of a monofunctional masking agent.

24. The compound as claimed in claim 23, in which the masking agent is as defined in claims 17 to 20.

25. The compound as claimed in claim 23 or claim 24, chosen from the compounds of the following formula: [chemical structure]
